(19) United States
(12) Patent Application Publication
(10) Pub. No.: US 2026/0266236 A1
(43) Pub. Date: Sep. 10, 2026

(54) Control Device

(71) Applicant: Astemo, Ltd., Chiyoda-ku, Tokyo (JP)

(72) Inventors: Akihiro KOMORI, Hitachinaka-shi, Ibaraki (JP); Kunihiko SUZUKI, Hitachinaka-shi, Ibaraki (JP)

(21) Appl. No.: 19/164,249

(22) PCT Filed: Mar. 28, 2023
(86) PCT No.: PCT/JP2023/012500

§ 371 Date: Sep. 11, 2025

(51) Int. Cl. F02D 41/14; F02D 41/00

(52) U.S. Cl. CPC F02D 41/1405; F02D 41/0007; F02D 41/1441; F02D 2041/1417; F02D 41/144; F02D 41/1446; F02D 41/1454; F02D 2200/0414

(57) ABSTRACT

The processor of the control device calculates the state variable at the second timing from the state variable (previous value) of the vehicle at the first timing, the control input of the vehicle at the second timing after the first timing, and the observation value (sensor input) at the second timing detected by the sensor of the vehicle. The processor approximates a state space model including a state equation related to a state variable and an observation equation related to an observation value with a neural network model. The processor determines the reliability of the state variable at the second timing from the control input at the second timing and the index (Mahalanobis distance) based on the observation value at the second timing.

### TECHNICAL FIELD

The present invention relates to a control device.

### BACKGROUND ART

Highly accurate power train control is required by the tightening of exhaust regulations, and control development using a neural network model has been advanced for improving the development efficiency of power train control conventionally configured by MAP control. The neural network model is a mathematical model imitating a mechanism of a human brain neural circuit.

### CITATION LIST

### Patent Literature

PTL 1: JP 2021-124419 A

### SUMMARY OF INVENTION

### Technical Problem

The control using the neural network model requires learning using the train data, and the neural network model operates in the learned region to ensure the accuracy of the operation result. However, in a case where the neural network model operates outside the learned region, there is a possibility that the accuracy deteriorates. In PTL 1 described above, whether the model can be learned is determined based on the reliability of the train data, but determining the reliability of the operation result of the learned model is not disclosed in PTL 1.

An object of the present invention is to provide a control device capable of evaluating the reliability of a calculated value of a state variable of a vehicle that is not detected by a sensor.

### Solution to Problem

In order to achieve the above object, a control device of the present invention includes a processor, in which the processor is configured to execute: calculating a state variable at a second timing from a state variable of a vehicle at a first timing, a control input of the vehicle at a second timing after the first timing, and an observation value at the second timing which is detected by a sensor of the vehicle; approximating, with a neural network model, a state space model including a state equation related to the state variable and an observation equation related to the observation value; and determining a reliability of the state variable at the second timing from an index based on the control input at the second timing and the observation value at the second timing.

### Advantageous Effects of Invention

According to the present invention, it is possible to evaluate the reliability of a calculated value of a state variable of a vehicle that is not detected by a sensor. Problems, configurations, and effects other than those described above will be clarified by the following description of embodiments.

### BRIEF DESCRIPTION OF DRAWINGS

FIG. 1 is an overall schematic configuration diagram of an internal combustion engine control system according to first and second embodiments of the present invention.

FIG. 2 is a block diagram illustrating a hardware configuration example of an ECU according to the first and second embodiments of the present invention.

FIG. 3 is a diagram illustrating an example of a neural network model according to the first embodiment of the present invention.

FIG. 4 is a flowchart illustrating an example of an algorithm of the extended Kalman filter according to the first embodiment of the present invention.

FIG. 5 is a diagram illustrating an outline of a Mahalanobis distance according to the first embodiment of the present invention.

FIG. 6 is a diagram illustrating an example of an actual behavior of the Mahalanobis distance according to the first embodiment of the present invention.

FIG. 7 is a block diagram of state quantity estimation and Mahalanobis distance calculation according to the first embodiment of the present invention.

FIG. 8 is a flowchart illustrating state quantity estimation and Mahalanobis distance calculation according to the first embodiment of the present invention.

FIG. 9A is a schematic diagram illustrating a configuration example of a post-processing system according to the second embodiment of the present invention.

FIG. 9B is a diagram for explaining a relationship between an equivalence ratio of exhaust gas and an output of an air-fuel ratio sensor according to the second embodiment of the present invention.

FIG. 9C is a diagram for explaining the relationship between an equivalence ratio of exhaust gas and an output of a rear oxygen sensor according to the second embodiment of the present invention.

FIG. 10A is a diagram for explaining a tendency with respect to an equivalence ratio of H₂O (water), CO (carbon monoxide), CO₂ (carbon dioxide), H₂ (hydrogen), and O₂ (oxygen) according to the second embodiment of the present invention.

FIG. 10B is a diagram for explaining a tendency with respect to an equivalence ratio of HC (hydrocarbon) and NOx (nitrogen oxides) according to the second embodiment of the present invention.

FIG. 11 is a diagram for explaining main reaction processes of a (ceria-based) three-way catalyst used in the post-processing system according to the second embodiment of the present invention.

FIG. 12 is a diagram for explaining a tendency of the purification rate of the three-way catalyst with respect to the exhaust gas equivalence ratio at a catalyst activation temperature or higher according to the second embodiment of the present invention.

FIG. 13 is a diagram for explaining a catalyst upstream equivalence ratio, a catalyst downstream equivalence ratio, and the output behavior of a rear oxygen sensor 22 according to the second embodiment of the present invention.

FIG. 14 is a graph for explaining hysteresis of output characteristics of a rear oxygen sensor according to the second embodiment of the present invention.

FIG. 15 is a diagram for explaining the output of the rear oxygen sensor according to the second embodiment of the present invention and temporal changes in the NOx concentration and the HC concentration downstream of the catalyst.

FIG. 16 is a diagram for explaining a relationship between the degree of catalyst deterioration and the oxygen storage capacity of the three-way catalyst according to the second embodiment of the present invention.

FIG. 17 is a diagram for explaining a relationship between an oxygen storage ratio of the three-way catalyst and an NOx purification rate of the three-way catalyst according to the second embodiment of the present invention.

FIG. 18 is a diagram for explaining a comparison result of the catalyst upstream equivalence ratio, the catalyst downstream equivalence ratio, the oxygen storage ratio, and the output behavior of the rear oxygen sensor in a case where a new catalyst and a deteriorated catalyst according to the second embodiment of the present invention are used.

FIG. 19 is a block diagram illustrating catalyst temperature estimation and Mahalanobis distance calculation according to the second embodiment of the present invention.

FIG. 20 is a flowchart illustrating catalyst temperature estimation and Mahalanobis distance calculation according to the second embodiment of the present invention.

FIG. 21 is a diagram illustrating an example of a neural network model according to the second embodiment of the present invention.

### DESCRIPTION OF EMBODIMENTS

Hereinafter, embodiments of the present invention will be described with reference to the accompanying drawings. In the present specification and the drawings, components having substantially the same function or configuration are denoted by the same reference numerals, and redundant description is omitted.

### First Embodiment

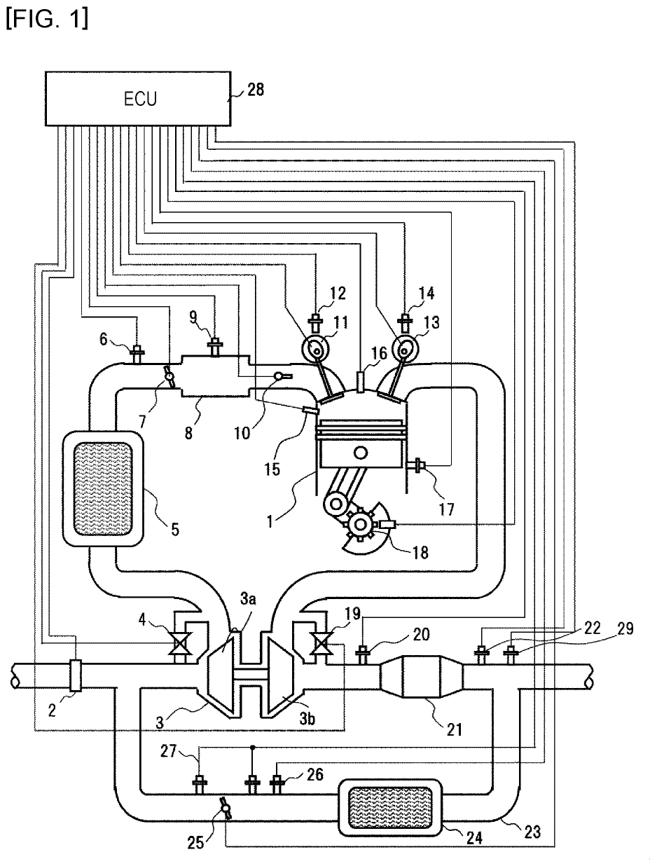

FIG. 1 is an overall schematic configuration diagram of an internal combustion engine control system 100.

The internal combustion engine control system 100 includes an internal combustion engine 1 and an electronic control unit (ECU) 28 attached to the internal combustion engine 1. The ECU 28 is electrically connected to various sensors, actuators, and the like constituting the internal combustion engine 1, and is an example of an internal combustion engine control device that controls the internal combustion engine 1.

The internal combustion engine 1 includes a flow rate sensor 2 (air flow sensor), a turbocharger 3, an air bypass valve 4, an intercooler 5, a supercharging temperature sensor 6, a throttle valve 7, an intake manifold 8, a supercharging pressure sensor 9, a flow enhancing valve 10, an intake valve 11, a valve opening/closing phase sensor 12, an exhaust valve 13, a valve opening/closing phase sensor 14, a fuel injection valve 15, an ignition plug 16, a knock sensor 17, a crank angle sensor 18, a wastegate valve 19, a catalyst upstream air-fuel ratio sensor 20, an exhaust purification catalyst (three-way catalyst) 21, a rear oxygen sensor (catalyst downstream oxygen sensor) 22, an EGR (exhausted gas recirculation) pipe 23, an EGR cooler 24, an EGR valve 25, an exhaust gas temperature sensor 26, a differential pressure sensor 27, and a catalyst downstream NOx sensor 29. The rear oxygen sensor 22 can be replaced with a catalyst downstream (rear) air-fuel ratio sensor (not illustrated).

An intake air temperature sensor (not illustrated) is assembled to the flow rate sensor 2 provided in the intake flow path of the internal combustion engine 1. The intake air temperature sensor measures an intake air temperature.

The turbocharger 3 includes a compressor 3a including a compressor blade facing an intake flow path, and a turbine 3b including a turbine blade facing an exhaust flow path and connected to the compressor 3a so as to rotate integrally. The compressor 3a and the turbine 3b are rotatably supported inside the turbocharger 3. Then, the turbine 3b converts energy of the exhaust gas from the internal combustion engine 1 into rotational energy. The compressor 3a connected to the turbine 3b compresses the intake air flowing in from the intake flow path by the rotational energy of the turbine 3b.

In the intake flow path of the internal combustion engine 1, the intercooler 5 is provided downstream of the compressor 3a of the turbocharger 3, and cools the intake air temperature of the intake air that has been adiabatically compressed and increased by the compressor 3a. The supercharging temperature sensor 6 is assembled downstream of the intercooler 5 and measures the temperature (supercharging temperature) of the intake air cooled by the intercooler 5.

The throttle valve 7 is provided downstream of the intercooler 5, narrows an intake flow path, and controls an intake air amount flowing into a cylinder of the internal combustion engine 1. The throttle valve 7 includes an electronically controlled butterfly valve capable of controlling a valve opening degree by the ECU 28. The intake manifold 8 to which the supercharging pressure sensor 9 is assembled communicates downstream of the throttle valve 7.

Note that the intake manifold 8 provided downstream of the throttle valve 7 and the intercooler 5 may be integrated. In this case, since the volume from the downstream of the compressor 3a to the cylinder can be reduced, it is possible to improve the responsiveness and controllability of acceleration/deceleration.

The air bypass valve 4 is disposed on an intake bypass flow path connecting the upstream side and the downstream side of the compressor 3a in the intake flow path in order to prevent the pressure from excessively increasing from the downstream side of the compressor 3a to the upstream portion of the throttle valve 7. For example, when the throttle valve 7 is rapidly closed in the supercharged state, the air bypass valve 4 is opened according to the control of the ECU 28, whereby the compressed intake air in the downstream portion of the compressor 3a flows back to the upstream portion of the compressor 3a through the bypass flow path. As a result, by immediately decreasing the supercharging pressure, a phenomenon called surging can be prevented, and damage of the compressor 3a can be appropriately prevented.

The flow enhancing valve 10 is disposed downstream of the intake manifold 8, and enhances the turbulence of the flow inside the cylinder by generating a drift in the intake air sucked into the cylinder. When the exhaust gas recirculation combustion described later is performed, the ECU 28 closes the flow enhancing valve 10 to promote the turbulent flow combustion and stabilize the combustion generated in the combustion chamber.

Each of the intake valve 11 and the exhaust valve 13 has a variable valve mechanism for continuously changing a phase of valve opening and closing. The valve opening/closing phase sensors 12 and 14 for detecting the opening/closing phase of the valve are respectively assembled to the variable valve mechanisms of the intake valve 11 and the exhaust valve 13. A cylinder of the internal combustion engine 1 includes the fuel injection valve 15 of a direct injection type that injects fuel pressurized by a fuel pump (not illustrated) into a combustion chamber of the cylinder. The fuel injection valve 15 may be of a port injection type that injects fuel into the intake flow path. Alternatively, as the fuel injection valve 15, a plurality of direct injection type or port injection type fuel injection valves 15 may be used in combination for each cylinder.

In a cylinder of the internal combustion engine 1, the ignition plug 16 that exposes an electrode portion in the cylinder and ignites a combustible air-fuel mixture by spark is assembled. The knock sensor 17 is provided in the cylinder block, and detects the presence or absence of knock by detecting cylinder block vibration caused by combustion pressure vibration generated in the combustion chamber. The crank angle sensor 18 is assembled in the vicinity of the crankshaft and outputs a signal corresponding to the rotation angle of the crankshaft to the ECU 28.

In the exhaust pipe of the internal combustion engine 1, the upstream air-fuel ratio sensor (catalyst upstream air-fuel ratio sensor 20) is disposed downstream of the turbine 3b of the turbocharger 3 and upstream of the three-way catalyst (exhaust purification catalyst 21) that is provided in the exhaust pipe and has oxygen storage capacity. Then, the upstream air-fuel ratio sensor (catalyst upstream air-fuel ratio sensor 20) detects the exhaust gas composition detected from the exhaust gas, that is, the catalyst upstream air-fuel ratio of the exhaust gas, and outputs a signal indicating the catalyst upstream air-fuel ratio to the ECU 28. The exhaust purification catalyst 21 is an example of a three-way catalyst, and is provided downstream of the catalyst upstream air-fuel ratio sensor 20. The exhaust purification catalyst 21 purifies harmful exhaust gas components such as carbon monoxide, nitrogen compounds, and unburned hydrocarbon in the exhaust gas by a catalytic reaction. As described above, the rear oxygen sensor 22 is disposed downstream of the exhaust purification catalyst 21. The rear oxygen sensor 22 detects the amount of oxygen contained in the exhaust gas after purification by the exhaust purification catalyst 21. Hereinafter, the exhaust purification catalyst 21 is also referred to as a three-way catalyst or a catalyst.

The turbocharger 3 includes an air bypass valve 4 and a wastegate valve 19. The air bypass valve 4 is disposed on a bypass flow path connecting the upstream side and the downstream side of the compressor 3a in order to prevent the pressure from excessively increasing from the downstream side of the compressor 3a to the upstream portion of the throttle valve 7. When the throttle valve 7 is rapidly closed in the supercharged state, the air bypass valve 4 is opened according to the control of the ECU 28, whereby the compressed intake air in the downstream portion of the compressor 3a flows back to the upstream portion of the compressor 3a through the bypass flow path. As a result, by immediately decreasing the supercharging pressure, a phenomenon called surging can be prevented, and damage of the compressor 3a can be appropriately prevented.

The wastegate valve 19 is disposed on an exhaust bypass flow path connecting the upstream side and the downstream side of the turbine 3b in the exhaust flow path. The wastegate valve 19 is an electric valve whose valve opening degree can be freely controlled with respect to supercharging pressure by control of the ECU 28. When the opening degree of the wastegate valve 19 is adjusted by the ECU 28 based on the supercharging pressure detected by the supercharging pressure sensor 9, a part of the exhaust gas passes through the bypass flow path, so that the energy given to the turbine 3b by the exhaust gas can be reduced. As a result, the wastegate valve 19 can adjust the supercharging pressure to the target pressure.

The EGR pipe 23 communicates an exhaust flow path in a downstream portion of the exhaust purification catalyst 21 and an intake flow path in an upstream portion of the compressor 3a, divides the exhaust gas from the downstream of the exhaust purification catalyst 21, and returns the exhaust gas to the upstream portion of the compressor 3a. The EGR cooler 24 provided in the EGR pipe 23 cools the divided exhaust gas. The EGR valve 25 is provided between the EGR cooler 24 and the upstream portion of the compressor 3a in the EGR pipe 23, and controls the flow rate of the exhaust gas recirculating to the upstream portion of the compressor 3a. The EGR pipe 23 is provided with the exhaust gas temperature sensor 26 that detects the exhaust gas temperature of the exhaust gas in the upstream portion of the EGR valve 25 and the differential pressure sensor 27 that detects the differential pressure between the upstream side and the downstream side of the EGR valve 25.

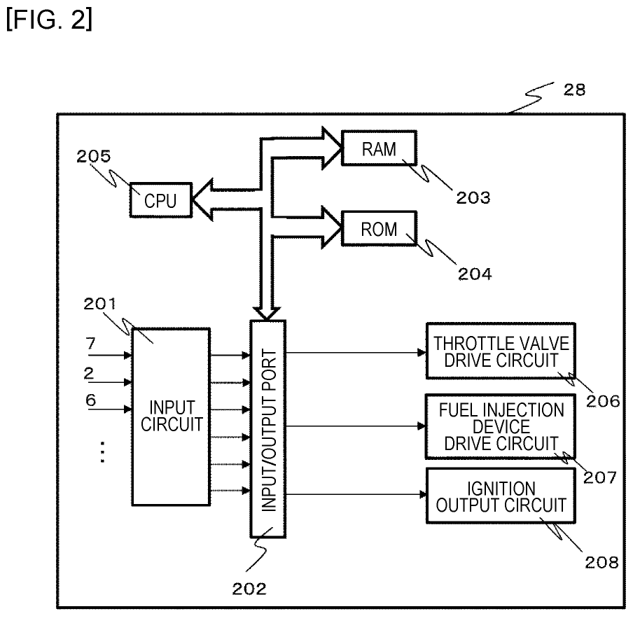

The ECU 28 includes an analog-to-digital (A/D) converter (not illustrated), a driver circuit, and the like in addition to a central processing unit (CPU) 205, a read only memory (ROM) 204, and a random access memory (RAM) 203 illustrated in FIG. 2 to be described later, and is a control device that controls each component of the internal combustion engine 1 and executes various data processes. The ECU 28 controls, for example, operations of actuators such as the throttle valve 7, the fuel injection valve 15, variable valve mechanisms of the intake valve 11 and the exhaust valve 13, and the EGR valve 25. In addition, the ECU 28 detects an operation state of the internal combustion engine 1 based on signals input from various sensors, and causes the ignition plug 16 to ignite at a timing determined according to the operation state.

### [Hardware Configuration Example of ECU]

FIG. 2 is a block diagram illustrating the hardware configuration example of the ECU 28.

The ECU 28 includes an input circuit 201, an input/output port 202, a RAM 203, a ROM 204, a CPU 205, a throttle valve drive circuit 206, a combustion injection valve drive circuit 207, and an ignition output circuit 208.

Output signals from various sensors are input to the input circuit 201. FIG. 2 illustrates an example in which output signals of the throttle sensor of the throttle valve 7, the flow rate sensor 2, the supercharging temperature sensor 6, the supercharging pressure sensor 9, the valve opening/closing phase sensors 12 and 14, the knock sensor 17, the crank angle sensor 18, the catalyst upstream air-fuel ratio sensor 20, the rear oxygen sensor 22, and the like are input to the input circuit 201 of the ECU 28. A signal input to the input circuit 201 is transmitted to the input/output port 202.

The signal transmitted to the input/output port 202 is stored in the RAM 203 and is subjected to arithmetic processing by the CPU 205. A control program describing the contents of the arithmetic processing is written in advance in the ROM 204 and is executed by the CPU 205. The ROM 204 records programs, data, and the like necessary for the operation of the CPU 205, and is used as an example of a computer-readable non-transitory storage medium having stored thereon a program executed by the ECU 28.

The control signal calculated by the CPU 205 according to the control program is output to each device such as the throttle valve drive circuit 206, the combustion injection valve drive circuit 207, and the ignition output circuit 208.

The throttle valve drive circuit 206 outputs a drive signal for controlling opening/closing drive of the throttle valve 7 to the throttle valve 7.

The combustion injection valve drive circuit 207 outputs a drive signal for controlling opening/closing drive of the fuel injection valve 15 at the fuel injection timing to the fuel injection valve 15.

The ignition output circuit 208 outputs a drive signal for controlling ignition of the ignition plug 16 at the ignition timing to the ignition output circuit 208.

### <Neural Network Model>

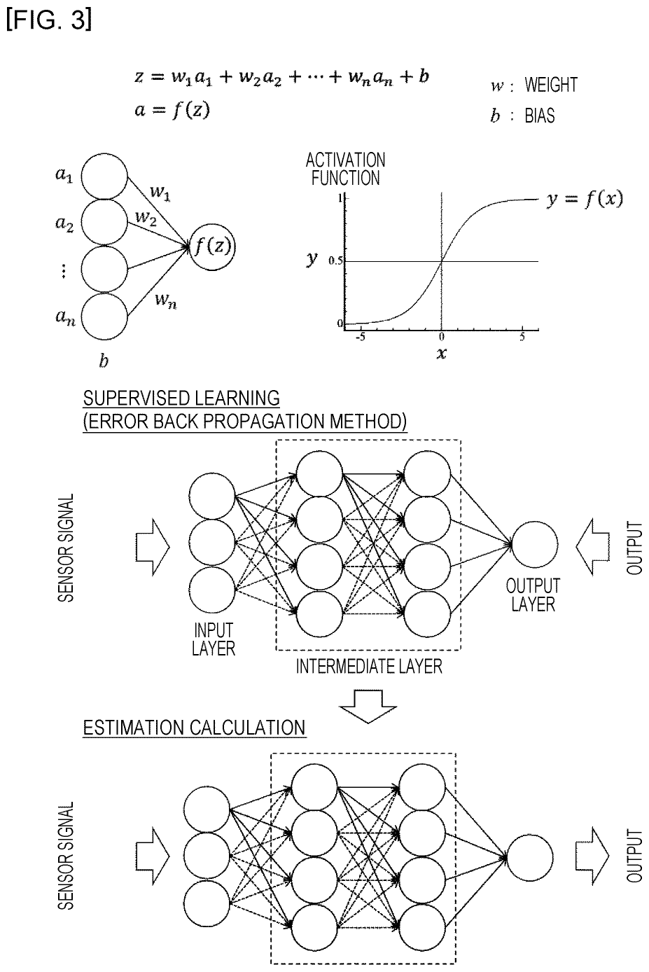

FIG. 3 illustrates an outline of the neural network. The neural network model is a mathematical model imitating a mechanism of a human brain neural circuit, and a weight and a bias are set to each neuron constituting the model.

In addition, a function called an activation function is defined for neurons. For the activation function, a logistic function, a ramp function, and the like are appropriately set. One layer is formed by a plurality of neurons, and an intermediate layer is set between the input layer and the output layer. By increasing the number of neurons and the number of intermediate layers, a more complicated input/output relationship can be approximated. There is a trade-off relationship between the approximate accuracy and the model scale, and a compromise point satisfying both requirements is selected. For example, the input/output relationship can be approximated by setting the frequency of the exhaust gas sensor signal to the input layer and setting the catalyst degeneration diagnosis to the output layer, and performing machine learning (supervised) on the weight and bias of each neuron. An error back propagation method can be applied to an algorithm of machine learning.

### <Extended Kalman Filter>

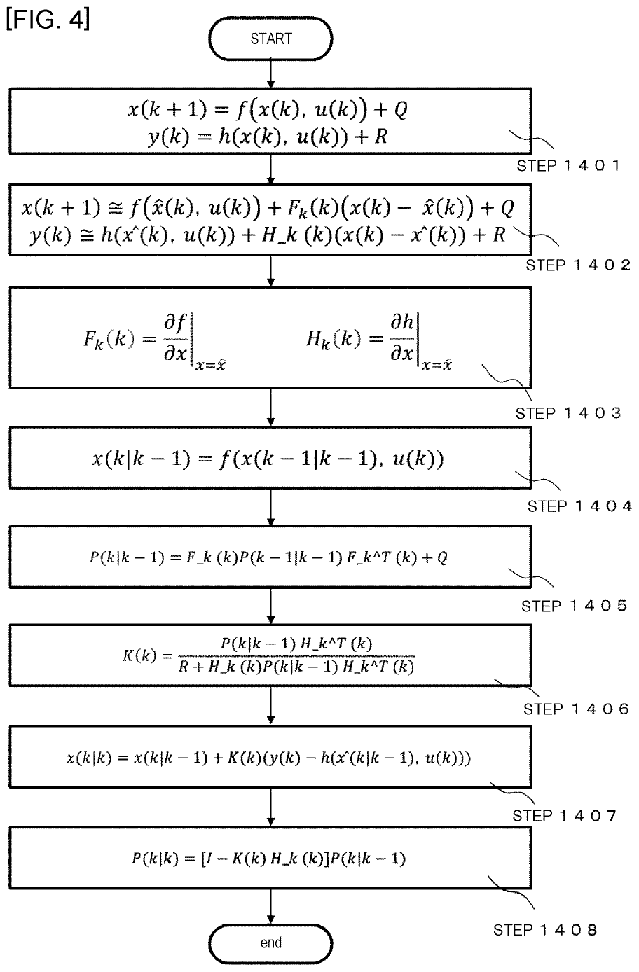

FIG. 4 is a flowchart illustrating an example of an extended Kalman filter algorithm. An algorithm and a method of applying an extended Kalman filter, which is one of the components of the present invention, to the present control will be described. Regarding the extended Kalman filter, an algorithm and an application method to the present control will be described. In the extended Kalman filter, a state/output equation including the system noise Q and the observation noise R defined in Expressions (1) and (2) is considered.

$$\begin{matrix}[ Math . 1 ] & \\ \begin{matrix}x ( k + 1 ) = f ( x ( k ) , u ( k ) ) + Q \\ y ( k ) = h ( x ( k ) , u ( k ) ) + R\end{matrix} \} & ( 1 )\end{matrix}$$

The above nonlinear equation is subjected to piecewise linear approximation as follows.

$$\begin{matrix}[ Math . 2 ] & \\ \begin{matrix}x ( k + 1 ) ≅ f ( \hat{x} ( k ) , u ( k ) ) + {F}_{k} ( k ) ( x ( k ) - \hat{x} ( k ) ) + Q \\ y ( k ) ≅ h ( \hat{x} ( k ) , u ( k ) ) + {H}_{k} ( k ) ( x ( k ) - \hat{x} ( k ) ) + R\end{matrix} \} & ( 2 )\end{matrix}$$

Here, Fₖ(k) and Hₖ(k) are Jacobian matrices related to the state variables of f and h, respectively.

$$\begin{matrix}[ Math . 3 ] & \\ {F}_{k} ( k ) = \frac{\partial f}{\partial x} {\vert}_{x = \hat{x}} , {H}_{k} ( k ) = \frac{\partial h}{\partial x} {\vert}_{x = \hat{x}} & ( 3 )\end{matrix}$$

The extended Kalman filter algorithm includes a prediction step and a filtering step. In the prediction step, the internal state variable vector and the covariance matrix are updated by the following expression based on the input variable and the system noise.

$$\begin{matrix}[ Math . 4 ] & \\ \begin{matrix}\hat{x} ( k \vert k + 1 ) = f ( \hat{x} ( k - 1 \vert k - 1 ) , u ( k ) ) \\ P ( k \vert k - 1 ) = {F}_{k} ( k ) P ( k - 1 \vert k - 1 ) {F}_{k}^{T} ( k ) + Q\end{matrix} \} & ( 4 )\end{matrix}$$

Next, in the filtering step, a Kalman gain defined by the updated covariance matrix and the observation noise is calculated.

$$\begin{matrix}[ Math . 5 ] & \\ K ( k ) = \frac{P ( k \vert k - 1 ) {H}_{k}^{T} ( k )}{R + {H}_{k} ( k ) P ( k \vert k - 1 ) {H}_{k}^{T} ( k )} & ( 5 )\end{matrix}$$

The internal state variable vector and the covariance matrix are updated by the following expression using the Kalman gain and the observation data.

$$\begin{matrix}[ Math . 6 ] & \\ \begin{matrix}x ( k \vert k ) = x ( k \vert k - 1 ) + K ( k ) ( y ( k ) - h ( \hat{x} ( k \vert k - 1 ) , u ( k ) ) \\ P ( k \vert k ) = [ I - K ( k ) {H}_{k} ( k ) ] P ( k \vert k - 1 )\end{matrix} \} & ( 6 )\end{matrix}$$

The time step is updated, and is returned to Expression (6). By repeating the above, it is possible to estimate the internal state variable that is difficult to directly measure based on the measured value.

### <Mahalanobis Distance>

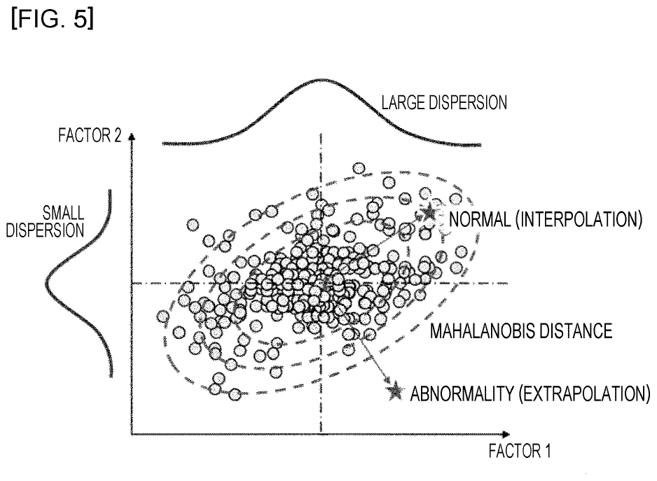

FIG. 5 illustrates a schematic diagram of the Mahalanobis distance. The Mahalanobis distance has a feature that it is easy to determine a normal value or an abnormal value even if distances from the center point are similar due to a combination of multidimensional variances. The Mahalanobis distance is calculated by the following expression. x represents an input data vector as in Expression (7). In addition, p represents an average value vector as in Expression (8).

$$\begin{matrix}[ Math . 7 ] & \\ x = {( {x}_{1} , {x}_{2} , … {x}_{n} )}^{T} & ( 7 )\end{matrix}$$

$$\begin{matrix}[ Math . 8 ] & \\ μ = {( {μ}_{1} , {μ}_{2} , … {μ}_{n} )}^{T} & ( 8 )\end{matrix}$$

Expression (9) represents a variance-covariance matrix. E is an expected value. The Mahalanobis distance D_{M} is obtained by Expression (10).

$$\begin{matrix}[ Math . 9 ] & \\ \sum = [ \begin{matrix}E [ ( {x}_{1} - {μ}_{1} ) ( {x}_{1} - {μ}_{1} ) ] & … & E [ ( {x}_{1} - {μ}_{1} ) ( {x}_{n} - {μ}_{n} ) ] \\ ⋮ & ⋱ & ⋮ \\ E [ ( {x}_{n} - {μ}_{n} ) ( {x}_{1} - {μ}_{1} ) ] & … & E [ ( {x}_{n} - {μ}_{n} ) ( {x}_{n} - {μ}_{n} ) ]\end{matrix} ] & ( 9 )\end{matrix}$$

$$\begin{matrix}[ Math . 10 ] & \\ {D}_{M} ( x ) = \sqrt{{( x - μ )}^{T} {\sum }^{- 1} ( x - μ )} & ( 10 )\end{matrix}$$

FIG. 6 illustrates an example of the actual behavior of the Mahalanobis distance. In the sections (a) and (c), a control input u exists in the interpolation region, and in the section (b), the control input u exists in the extrapolation region. In the section (c), the sensor used in the extended Kalman filter is abnormal, and an abnormal sensor value is input. Next, the behavior of the Mahalanobis distance for each section will be described. In the section (a), since the control input u is in the interpolation region and the sensor is operating normally, the Mahalanobis distance is small and the estimation accuracy is good. In the section (b), since the control input u is in the extrapolation region, the Mahalanobis distance increases, and the estimation accuracy is worse than that in the section (a). In the section (c), the control input u is in the interpolation region, but since the sensor used for the extended Kalman filter outputs an abnormal value, the Mahalanobis distance increases, and the estimation accuracy is worse than that in the section (a). As described above, when the control input or the sensor operates abnormally, the reliability of the estimated value of the state observer can be determined by increasing the Mahalanobis distance.

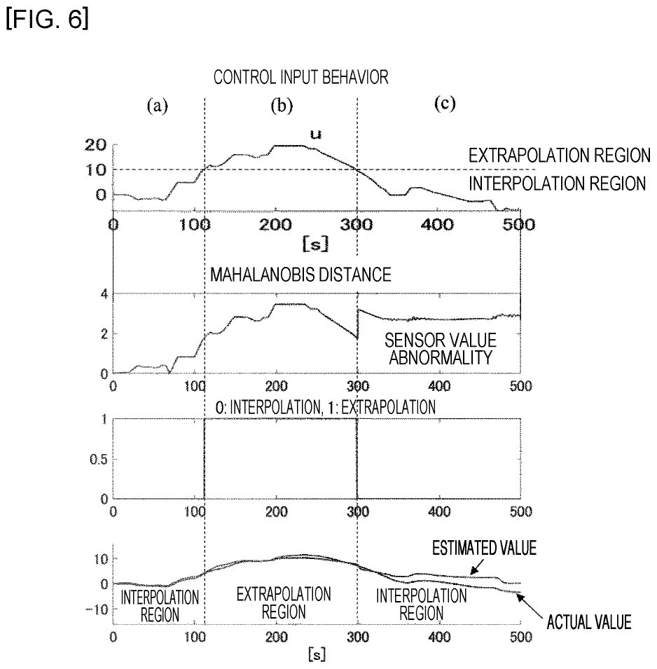

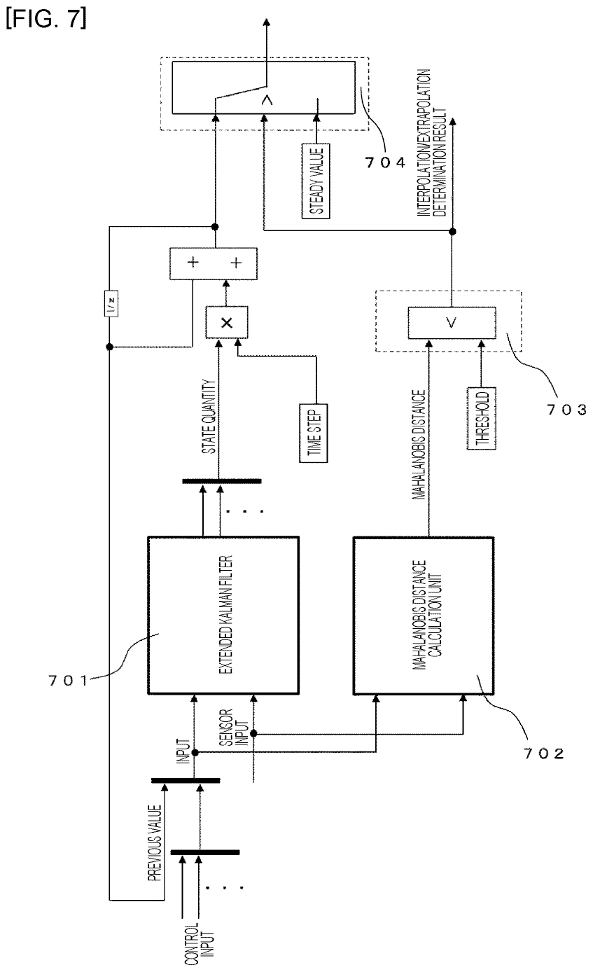

Next, the configuration of the present embodiment will be described with reference to FIG. 7. First, an arbitrary input value input from the ECU is input to an extended Kalman filter 701. The input value includes a control value and a sensor value. The state quantity is estimated using the input value. Here, since the state quantity is a differential value, an integral calculation is performed using a prescribed time step value and a previous value state quantity to obtain a current state quantity. At the same time, the input value of the same type as that of the extended Kalman filter 701 is input also in a Mahalanobis distance calculation unit 702. The Mahalanobis distance at the current input is calculated using the input value. A comparison unit 703 compares the prescribed threshold with the calculated Mahalanobis distance. In a case where the current Mahalanobis distance is larger than the threshold, 0 is output, and it is regarded that the current Mahalanobis distance is out of the learning range or the sensor is faulty. In a case where the current Mahalanobis distance is smaller than the threshold, 1 is output, and it is determined that the current Mahalanobis distance is within the learning range or the sensor is normal. Then, an interpolation/extrapolation result is recorded. In a switching unit 704, in a case where 0 is input, it is assumed that the extended Kalman filter 701 is operating outside the learning range or the sensor fault is occurring and a normal estimation calculation cannot be performed, and a prescribed steady value is output. In a case where 1 is input, it is regarded that the extended Kalman filter 701 is operating within the learning range or the sensor is operating normally and normal estimation calculation can be performed, and the estimated state quantity is output.

Next, a flowchart of the present embodiment will be described with reference to FIG. 8. In step 801, control inputs and sensor input values are received from the ECU. In step 802, the Mahalanobis distance is obtained from the ECU using the control input and the sensor input value. In step 803, the threshold defined in step 802 is compared with the calculated Mahalanobis distance. If it is smaller than the threshold, the process proceeds to step 804, and if it is larger than the threshold, the process proceeds to step 805. When the process proceeds to step 804, since the extended Kalman filter is operating within the learning range or the sensor is operating normally, the state quantity (differential value) is estimated by the extended Kalman filter using the control input and the sensor input value from the ECU, and the integral calculation is performed using the prescribed time step value and the previous value state quantity to obtain the current state quantity.

When the process proceeds to step 805, since the extended Kalman filter is operating outside the learning range or the sensor is faulty, the diagnosis result is recorded and used as the sensor failure or the relearning data. An alternative value such as the estimated value calculated by the physical expression in step 806 or the output value of MAP defined at the operating point is output.

### Second Embodiment

In a second embodiment, the temperature estimation of the catalyst will be described by way of example.

### <Configuration Example of Post-Processing System>

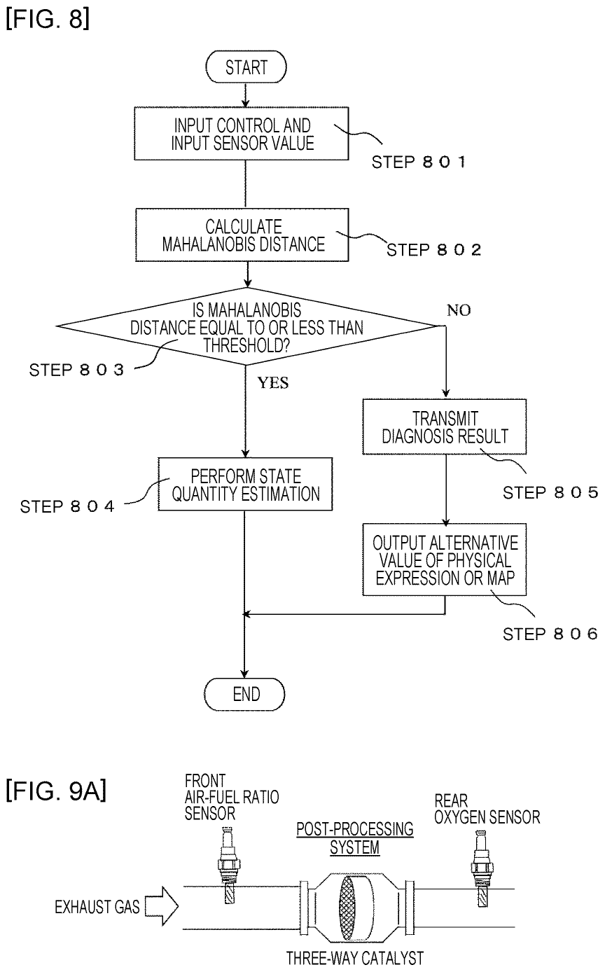

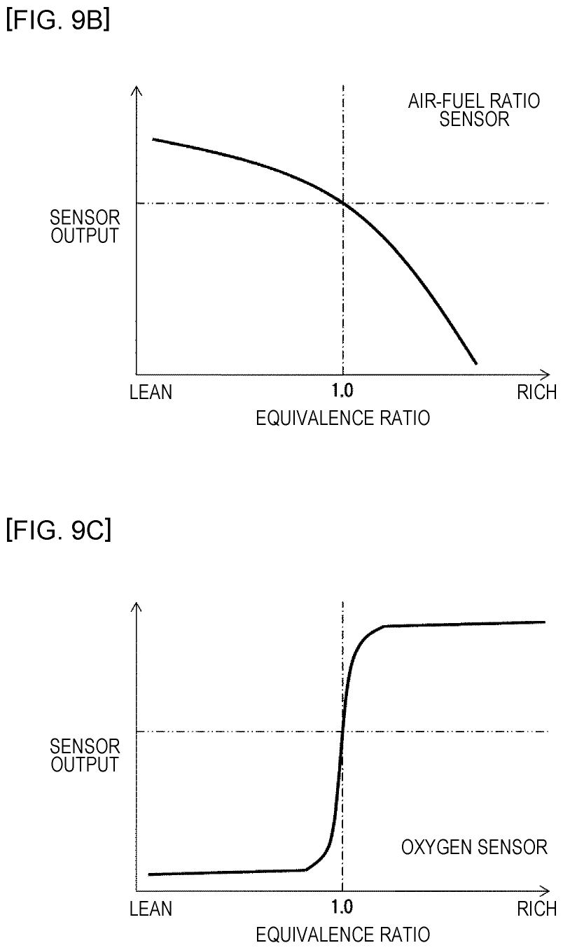

Next, a configuration example of a post-processing system 110 that purifies the exhaust gas of the internal combustion engine will be described with reference to FIGS. 9A to 9C.

FIG. 9A is a schematic diagram illustrating a configuration example of the post-processing system 110.

As described above, in the post-processing system 110, a three-way catalyst is used as the exhaust gas purification catalyst (the exhaust purification catalyst 21). A catalyst upstream air-fuel ratio sensor 20 is provided in an upstream portion of the three-way catalyst, a rear oxygen sensor 22 is provided in a downstream portion, and the catalyst upstream air-fuel ratio sensor 20 and the rear oxygen sensor 22 are connected to a control device such as the ECU 28. The ECU 28 can measure the catalyst upstream air-fuel ratio of the exhaust gas flowing into the three-way catalyst via the catalyst upstream air-fuel ratio sensor 20 and detect the amount of oxygen contained in the exhaust gas after catalyst purification via the rear oxygen sensor 22.

FIG. 9B is a diagram for explaining the relationship between the equivalence ratio (=stoichiometric air-fuel ratio/air-fuel ratio) of the exhaust gas and the output of the catalyst upstream air-fuel ratio sensor 20. In FIG. 9B, the horizontal axis represents the equivalence ratio, and the vertical axis represents the output of the catalyst upstream air-fuel ratio sensor 20.

As illustrated in FIG. 9B, the output of the catalyst upstream air-fuel ratio sensor 20 (air-fuel ratio sensor output) tends to decrease as the equivalence ratio increases (in other words, as the exhaust gas becomes richer). The ECU 28 converts the catalyst upstream air-fuel ratio sensor signal into the catalyst upstream air-fuel ratio based on the relationship between the equivalence ratio of the exhaust gas and the output of the catalyst upstream air-fuel ratio sensor 20. As a result, the ECU 28 can accurately detect the catalyst upstream air-fuel ratio in a wide range from the lean state to the rich state of the exhaust gas.

FIG. 9C is a diagram for explaining the relationship between the equivalence ratio of the exhaust gas and the output of the rear oxygen sensor 22. In FIG. 9C, the horizontal axis represents the equivalence ratio, and the vertical axis represents the rear oxygen sensor output.

The rear oxygen sensor output is also read as a rear oxygen sensor voltage, and is changed by an electromotive force associated with a concentration difference between the oxygen concentration contained in the exhaust gas and the oxygen concentration in the air. The rear oxygen sensor output shows substantially the minimum electromotive force in the lean condition, and shows the maximum electromotive force in the rich condition. Therefore, in the catalyst control, the rear oxygen sensor output has a characteristic of rapidly changing at the stoichiometric air-fuel ratio (equivalence ratio 1.0). The ECU 28 can detect the amount of oxygen of the exhaust gas released downstream of the three-way catalyst by capturing the change timing of the rear oxygen sensor output.

### <Chemical Species Concentration of Exhaust Gas>

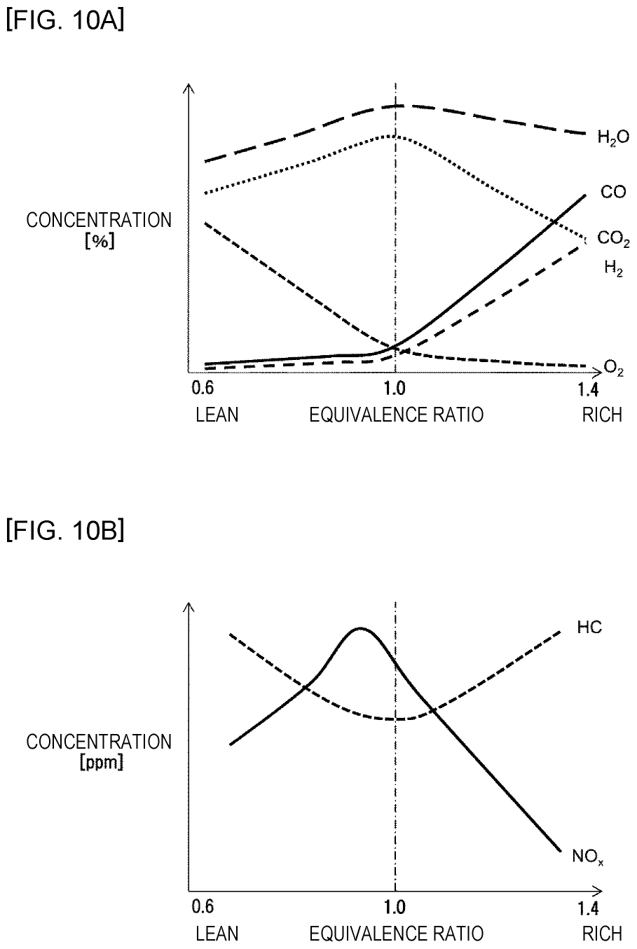

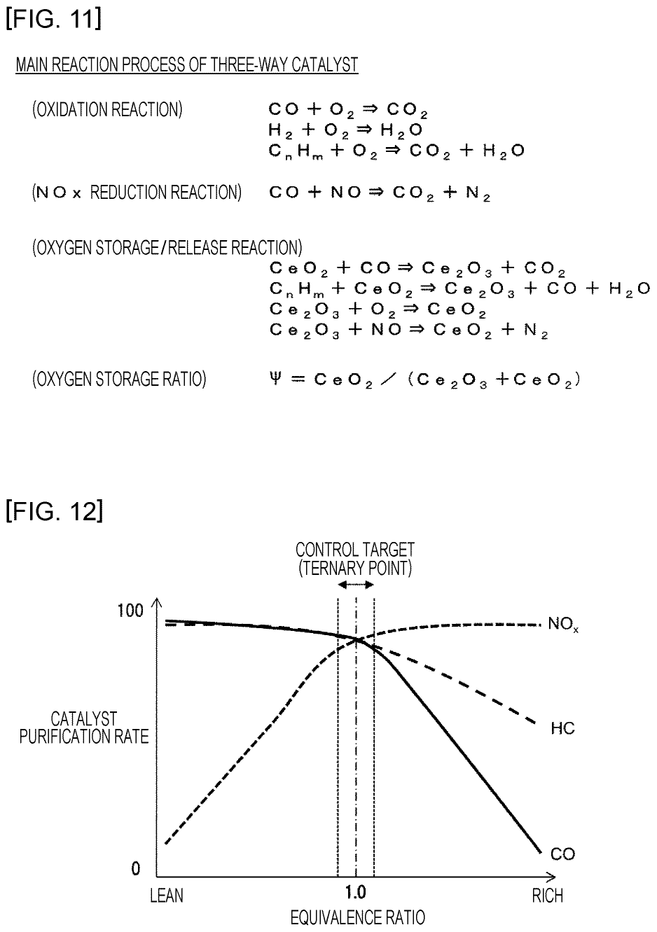

FIGS. 10A and 10B are diagrams for explaining a tendency of the chemical species concentration of the exhaust gas with respect to the equivalence ratio.

FIG. 10A is a diagram for explaining a tendency with respect to an equivalence ratio of H₂O (water), CO (carbon monoxide), CO₂ (carbon dioxide), H₂ (hydrogen), and O₂ (oxygen).

FIG. 10B is a diagram for explaining a tendency with respect to an equivalence ratio of HC (hydrocarbon) and NOx (nitrogen oxide). In FIGS. 10A and 10B, the horizontal axis represents the equivalence ratio, and the vertical axis represents the concentration of the chemical species of the exhaust gas.

As illustrated in FIG. 10A, in the combustion gas composition of the hydrocarbon-based fuel, CO (carbon monoxide) and H₂ (hydrogen) tend to increase on the rich side and O₂ (oxygen) tends to increase on the lean side with the stoichiometric air-fuel ratio as a boundary. On the other hand, as illustrated in FIG. 10B, NOx (nitrogen oxide) shows a local maximum value on a slightly lean side of the stoichiometric air-fuel ratio, and tends to decrease on the lean side and the rich side. HC (unburned hydrocarbon) is an unburned fuel component that is discharged without reaching combustion, and shows a local minimum value in the stoichiometric air-fuel ratio, and when the fuel is excessively lean or rich with the stoichiometric air-fuel ratio as a boundary, the amount of HC discharged without reaching complete combustion tends to increase.

As illustrated in FIGS. 10A and 10B, even under the stoichiometric air-fuel ratio condition in which fuel and air (oxygen) are supplied without excess or deficiency, a certain amount of CO (carbon monoxide) or NOx (nitrogen oxide) is discharged without reaching H₂O (water) or CO₂ (carbon dioxide) in the high-temperature combustion gas. For this reason, it is necessary to properly purify the exhaust gas by the post-processing system 110.

### <Reaction Process of Three-Way Catalyst>

FIG. 11 is a diagram for explaining a main reaction process of a (ceria-based) three-way catalyst used in the post-processing system 110. In the reaction process illustrated in FIG. 11, description of coefficients is omitted.

The reaction process of the three-way catalyst mainly includes an oxidation reaction, an NOx reduction reaction, and an oxygen storage/release reaction. In the oxidation reaction, CO, H₂, and HC generated under rich or high temperature conditions react with oxygen to generate harmless CO₂ and H₂O. Unburned hydrocarbon (HC) contains components such as methane, propane, ethylene, and butane, and the reaction proceeds at different rates.

The NOx reduction reaction is mainly represented by a reaction between CO and NO, and CO₂ and N₂ are generated.

In the oxygen storage/release reaction, storage/release of oxygen (O₂) and each oxidation/reduction reaction of HC, CO, and NO proceed via Ce (cerium) which is a catalyst material. That is, CO₂ and H₂O are generated by the reaction of cerium dioxide (CeO₂) with CO and HC, and N2 is generated by the reaction of dicerium trioxide (Ce₂O₃) with NO. At this time, an oxygen storage ratio Ψ of the three-way catalyst is defined by the balance between CeO₂ and Ce₂O₃ generated simultaneously. That is, when all of Ce₂O₃ in the catalyst becomes CeO₂, the reaction with NO cannot be performed, and NO cannot be purified.

As described above, in order to appropriately maintain the purification rate of the three-way catalyst, it is necessary to maintain the balance between CeO₂ and Ce₂O₃, that is, the oxygen storage ratio V at a predetermined value. Since all the above-described reaction processes strongly depend on the catalyst temperature, the ECU 28 needs to appropriately perform catalyst temperature management so that the temperature becomes equal to or higher than the activation temperature early after the start of the internal combustion engine 1.

In the system shown in the present embodiment, a ceria-based three-way catalyst is used, but the present invention is not limited thereto. Even in a catalyst using another material exhibiting a similar effect, the same effect can be exhibited without changing the configuration of the invention by adjusting the constant of the control model. In the catalytic reaction, an aqueous gas shift reaction or the like may be used in addition to the reaction mechanism illustrated in FIG. 11. The ECU 28 can also cope with these reaction mechanisms by adjusting the control model constant.

FIG. 12 is a diagram for explaining a tendency of the purification rate of the three-way catalyst with respect to the exhaust gas equivalence ratio at the catalyst activation temperature or higher. In FIG. 12, the equivalence ratio is taken on the horizontal axis, and the catalyst purification rate is taken on the vertical axis. FIG. 12 illustrates the catalyst purification rates of NOx, HC, and CO when the equivalence ratio changes from lean to rich. The catalyst purification rate closer to 100% indicates that the components in the exhaust gas are purified and the components in the exhaust gas are not discharged.

This graph shows that the purification rate characteristics of the three-way catalyst change with a stoichiometric air-fuel ratio (“control target” in the figure) as a boundary. Under the lean condition, while the purification rates of CO and HC are maintained at about 90% or more, the NOx purification rate decreases as the equivalence ratio decreases. On the rich side, the purification rates of HC and CO tend to decrease as the equivalence ratio increases. In the vicinity of the stoichiometric air-fuel ratio, the purification rate of any of NOx, HC, and CO can achieve 90% or more. Therefore, a point near the stoichiometric air-fuel ratio is referred to as a “ternary point”. The ECU 28 performs control to keep the purification rate of the three-way catalyst high by keeping the equivalence ratio at the stoichiometric air-fuel ratio which is the ternary point.

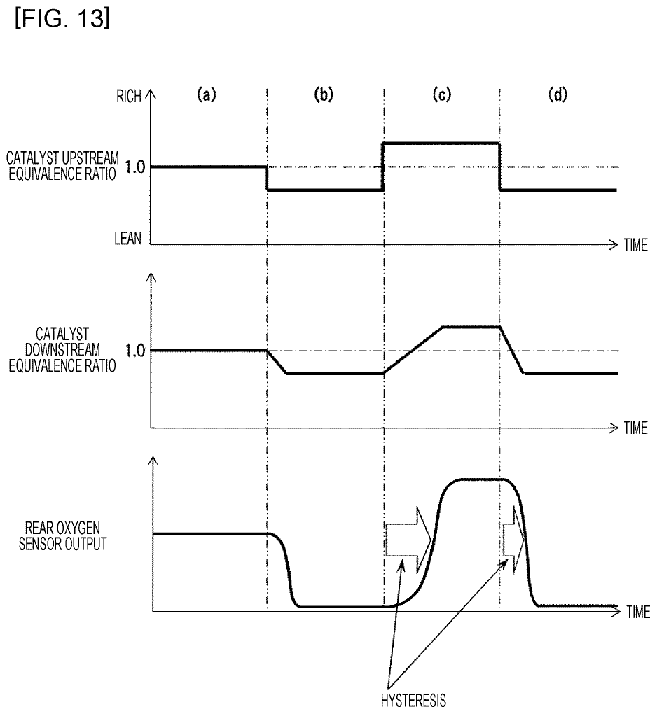

FIG. 13 is a diagram for explaining the catalyst upstream equivalence ratio, the catalyst downstream equivalence ratio, and the output behavior of the rear oxygen sensor 22. In FIG. 13, the horizontal axis represents time, and the vertical axis represents the catalyst upstream equivalence ratio, the catalyst downstream equivalence ratio, and the rear oxygen sensor output. Here, the equivalence ratio (catalyst downstream air-fuel ratio) on the downstream side of the catalyst and the output behavior of the rear oxygen sensor 22 installed on the downstream side of the catalyst when the catalyst upstream equivalence ratio (catalyst upstream air-fuel ratio) is rapidly changed stepwise (step-like) in terms of time to the lean side or the rich side with the equivalence ratio 1.0 as the center are shown. First, as shown in a time zone (a) along the time axis in the left-right direction in FIG. 13, when the catalyst upstream equivalence ratio is set to exactly 1.0, a fine amount of oxygen is discharged downstream of the catalyst. Therefore, the rear oxygen sensor output is held in an intermediate state that is a value between the maximum electromotive force and the minimum electromotive force. Subsequently, as illustrated in a time zone (b) in FIG. 13, when the catalyst upstream equivalence ratio is decreased from the equivalence ratio 1.0 and changed stepwise to the lean side, the catalyst downstream equivalence ratio gradually decreases to the lean side, and the rear oxygen sensor output rapidly changes to a predetermined minimum electromotive force value side under the lean condition after a relaxation time required for the gradual decrease in the catalyst downstream equivalence ratio. Subsequently, as illustrated in a time zone (c) in FIG. 13, when the catalyst upstream equivalence ratio is increased more than the equivalence ratio 1.0 and changed stepwise to the rich side, the catalyst downstream equivalence ratio starts gradually increasing to the rich side accordingly. The rear oxygen sensor output changes to a predetermined maximum electromotive force value side under the rich condition after a relaxation time required for the gradual increase in the catalyst downstream equivalence ratio. Next, as illustrated in the time zone (d) in FIG. 13, when the catalyst upstream equivalence ratio is decreased again from the equivalence ratio 1.0 and changed stepwise to the lean side, the catalyst downstream equivalence ratio gradually decreases again to the lean side. The rear oxygen sensor output corresponding to the change in the catalyst upstream equivalence ratio changes to the predetermined minimum electromotive force value side under the lean condition again after the relaxation time required for the gradual decrease in the catalyst downstream equivalence ratio. The time required for the change from rich to lean in the catalyst downstream equivalence ratio in the time zone (d) is shorter than the time required for the change from lean to rich in the time zone (c), that is, has so-called hysteresis.

As described above, in the change from lean to rich and the change from rich to lean, the delay time of the catalyst downstream equivalence ratio and the delay time of the output of the rear oxygen sensor 22 tend to be different. This tendency is attributed to the fact that the reaction rates in the oxygen storage/release reaction of CeO₂ and Ce₂O₃ of the (ceria-based) three-way catalyst described in FIG. 11 are different depending on the change from rich to lean and the change from lean to rich. Since the reaction rate of the three-way catalyst also depends on the catalyst temperature and the exhaust gas flow rate, the hysteresis changes depending on the catalyst temperature and the exhaust gas flow rate.

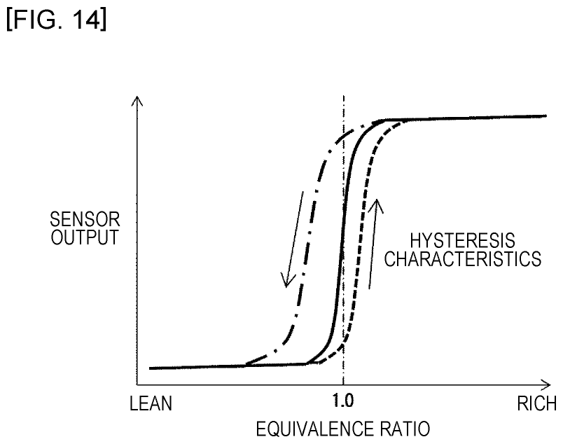

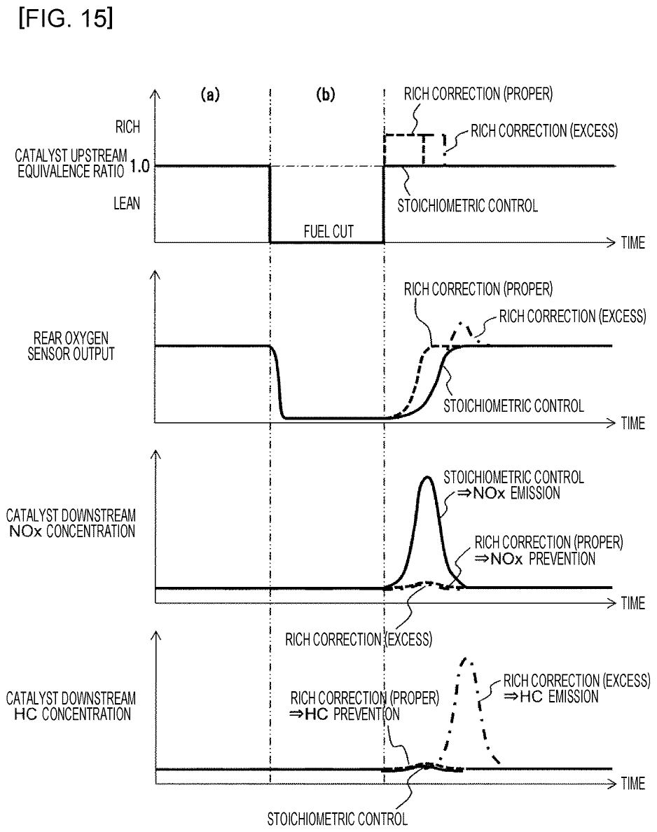

Next, the hysteresis of the oxygen sensor characteristic will be described with reference to FIG. 14. FIG. 14 is a diagram for explaining hysteresis of output characteristics of the oxygen sensor. In this graph, the horizontal axis represents the equivalence ratio, and the vertical axis represents the output of the oxygen sensor. The static characteristics of the oxygen sensor are as described with reference to FIG. 9C. On the other hand, the above-described catalyst material is also used for the oxygen sensor. Therefore, the dynamic characteristic of the oxygen sensor has hysteresis in which the change from rich to lean and the change from lean to rich are different. That is, the relaxation time required when the oxygen sensor signal changes from the predetermined maximum electromotive force value side under the rich condition to the predetermined minimum electromotive force value side under the lean condition is shorter than the relaxation time required when the oxygen sensor signal changes from the predetermined minimum electromotive force value side under the lean condition to the predetermined maximum electromotive force value side under the rich condition. Furthermore, the behavior of the oxygen sensor signal described above is affected by a change in the use process of the material properties constituting the oxygen sensor and the temperature of the oxygen sensor.

Here, with reference also to FIG. 15, the temporal change of the output of the rear oxygen sensor 22 and the catalyst downstream NOx concentration in the case of returning the operation to the stoichiometric air-fuel ratio state again from the state (stoichiometric control) in which the internal combustion engine 1 is controlled at a catalyst upstream equivalence ratio of 1.0 (stoichiometric air-fuel ratio) through the period (lean condition) in which the fuel cut is performed will be described. FIG. 15 is a diagram for explaining the output of the rear oxygen sensor 22 and the temporal changes in the NOx concentration and the HC concentration downstream of the catalyst. In FIG. 15, the horizontal axis represents time, and the vertical axis represents the catalyst upstream equivalence ratio, the rear oxygen sensor output, the catalyst downstream NOx concentration, and the catalyst downstream HC concentration. First, when the catalyst upstream equivalence ratio is set to exactly 1.0 as shown in a time zone (a) along the time axis in the left-right direction in FIG. 15, the rear oxygen sensor output is held in an intermediate state that is a value between the maximum electromotive force and the minimum electromotive force. Subsequently, as shown in a time zone (b) in FIG. 15, the operation with a catalyst upstream equivalence ratio of 1.0 is shifted to a lean condition by the fuel cut. Subsequently, as shown in a time zone (c) in FIG. 15, the operation returns to the operation with a catalyst upstream equivalence ratio of 1.0 again. At this time, the change from the intermediate state of a catalyst upstream equivalence ratio of 1.0 of the rear oxygen sensor output to the lean side and the change from the lean side to the intermediate state of a catalyst upstream equivalence ratio of 1.0 (relaxation time) are different. That is, the relaxation time required when the oxygen sensor signal changes from the predetermined minimum electromotive force value side under the lean condition by the fuel cut to the intermediate state (see the time zone (a) in FIG. 15) under the stoichiometric control condition is longer than the relaxation time required when the oxygen sensor signal changes from the intermediate state under the stoichiometric control condition to the predetermined minimum electromotive force value side under the lean condition. During the relaxation time (delay period) until the rear oxygen sensor output returns to the intermediate state, a behavior in which the NOx concentration in the downstream of the catalyst increases in a spike manner may be observed. For such an increase in the NOx concentration in the downstream of the catalyst, for example, when the operation with a catalyst upstream equivalence ratio of 1.0 is started again after the fuel cut, a so-called rich correction is performed to temporarily increase the catalyst purification rate of NOx by increasing the catalyst upstream equivalence ratio more than the equivalence ratio of 1.0 (see FIG. 12) and thereby reduce the NOx emission amount in the downstream of the catalyst, and control is performed to cope with the increase in the NOx concentration. However, there is a trade-off relationship between increasing the catalyst purification rate of NOx by the rich correction and the catalyst purification rates of HC and CO (see FIG. 12). Therefore, in the air-fuel ratio control of the internal combustion engine 1, it is necessary to perform rich correction control of an appropriate correction amount and period in consideration of the state inside the catalyst. In order to consider the state inside the catalyst in the air-fuel ratio control of the internal combustion engine 1, for example, a rear oxygen sensor signal that detects the oxygen state of the exhaust gas downstream of the catalyst can be used as a determination reference. However, as described above, it should be noted that the reaction of the rear oxygen sensor 22 has a delay period (see FIG. 14).

Here, temporal changes in the output of the rear oxygen sensor 22 and the NOx concentration and the HC concentration downstream of the catalyst will be described in the order of the stoichiometric control, the appropriate rich correction, and the excessive rich correction.

### (Stoichiometric Control)

In FIG. 15, the output of the rear oxygen sensor 22 and the temporal changes of the NOx concentration and the HC concentration downstream of the catalyst when the stoichiometric control is performed are indicated by solid lines. As illustrated in FIG. 13, the output of the rear oxygen sensor 22 increases with a delay with respect to the change from the lean state to the rich state. The NOx concentration downstream of the catalyst indicates a behavior in which momentarily increased NOx is discharged during a delay period until the output of the rear oxygen sensor 22 returns. On the other hand, since the HC concentration downstream of the catalyst is substantially unchanged, HC emission is prevented.

### (Appropriate Rich Correction)

In FIG. 15, the output of the rear oxygen sensor 22 and the temporal changes of the NOx concentration and the HC concentration downstream of the catalyst when the appropriate rich correction is performed are indicated by broken lines. When the firing operation is started again after the fuel cut, once the rich correction is performed, the catalyst upstream equivalence ratio comes into a rich state. The output of the rear oxygen sensor 22 reaches the equivalence ratio earlier than the stoichiometric control. In addition, since the NOx concentration and the HC concentration in the downstream of the catalyst are substantially unchanged, NOx and HC emission is prevented.

### (Excessive Rich Correction)

In FIG. 15, the output of the rear oxygen sensor 22 and the temporal changes of the NOx concentration and the HC concentration downstream of the catalyst when excessive rich correction is performed are indicated by rough broken lines. The rear oxygen sensor 22 detects the oxygen state of the downstream gas of the catalyst. Therefore, when the excessive rich correction is performed, the internal state of the catalyst has already changed to a state where the oxygen storage state is maximized or minimized at the time when the output of the rear oxygen sensor 22 reacts. When the excessive rich correction is performed, the NOx concentration decreases as illustrated in FIG. 10B, and the catalyst purification rate of NOx increases as illustrated in FIG. 12, so that NOx emission is prevented.

On the other hand, since the HC concentration increases as illustrated in FIG. 10B and the catalyst purification rate of HC decreases as illustrated in FIG. 12, HC is discharged. That is, when the control method of stopping the rich correction after the output of the rear oxygen sensor 22 reacts is adopted, HC cannot be appropriately prevented because the stop timing of the rich correction is too late for the catalyst. Therefore, in the air-fuel ratio control of the internal combustion engine, it is necessary to perform rich correction control for an appropriate period in consideration of the state inside the catalyst that cannot be directly observed from the outside.

FIG. 16 is a diagram for explaining the relationship between the degree of catalyst deterioration and the oxygen storage capacity (OSC) of the three-way catalyst. In FIG. 16, the horizontal axis represents the degree of catalyst deterioration, and the vertical axis represents the oxygen storage capacity.

The catalyst deterioration refers to a state in which the catalytic action of the three-way catalyst is reduced due to the thermal influence and the influence of poisoning by sulfur contained in the fuel. As illustrated in FIG. 16, the oxygen storage capacity of the three-way catalyst is substantially proportional to the degree of catalyst deterioration in the left-right direction in FIG. 16. That is, the oxygen storage capacity of the three-way catalyst tends to decrease as the catalyst deterioration progresses.

Hereinafter, the influence of the change in oxygen storage capacity on the purification action of the three-way catalyst will be described.

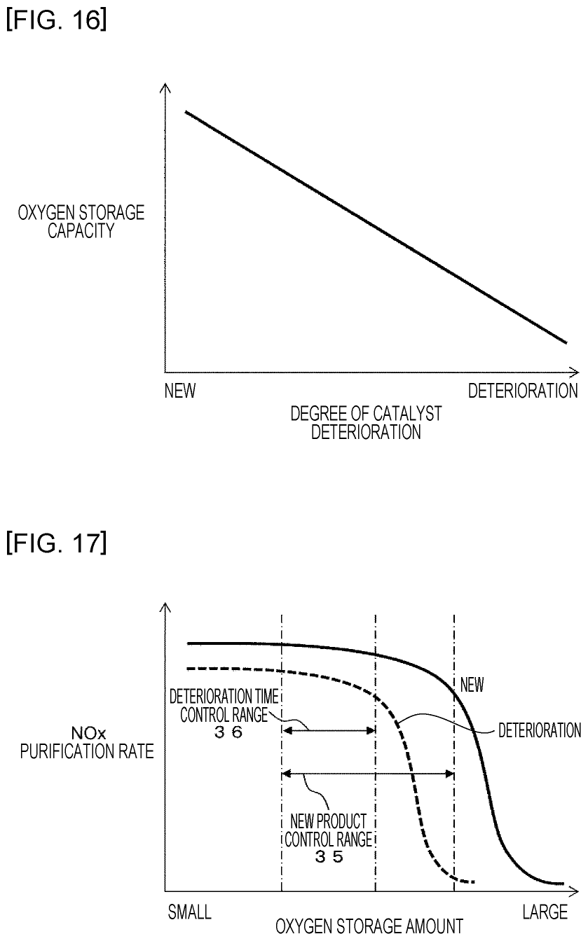

FIG. 17 is a diagram for explaining the relationship between the oxygen storage ratio of the three-way catalyst, that is, the value obtained by dividing the current oxygen storage amount of the three-way catalyst by the above-described oxygen storage capacity, and the NOx purification rate. In FIG. 17, the horizontal axis represents the oxygen storage ratio, and the vertical axis represents the NOx purification rate. In FIG. 17, the change in the NOx purification rate of the new three-way catalyst is represented by a solid line, and the change in the NOx purification rate of the deteriorated three-way catalyst is represented by a broken line. When the oxygen storage ratio is small, both the new three-way catalyst and the deteriorated three-way catalyst have a high oxygen storage ratio. In addition, the new three-way catalyst has a higher NOx purification rate than the deteriorated three-way catalyst. As illustrated in FIG. 17, when the oxygen storage ratio exceeds a predetermined value, the NOx purification rates of both the new three-way catalyst and the deteriorated three-way catalyst tend to deteriorate rapidly. This is because, as described with reference to FIG. 11, Ce₂O₃ in the catalyst is important for NOx purification, and when all of Ce₂O₃ reacts and changes to CeO₂, Ce₂O₃ cannot react with NO and NOx cannot be purified. In addition, when the oxygen storage capacity of the three-way catalyst decreases as the catalyst deterioration progresses, as a result, the value of the oxygen storage ratio with respect to the same oxygen storage amount increases.

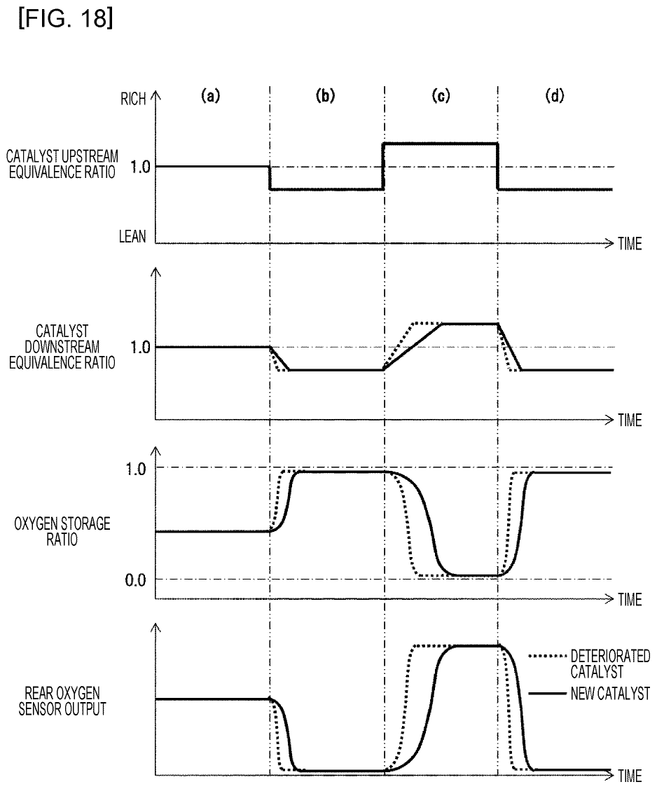

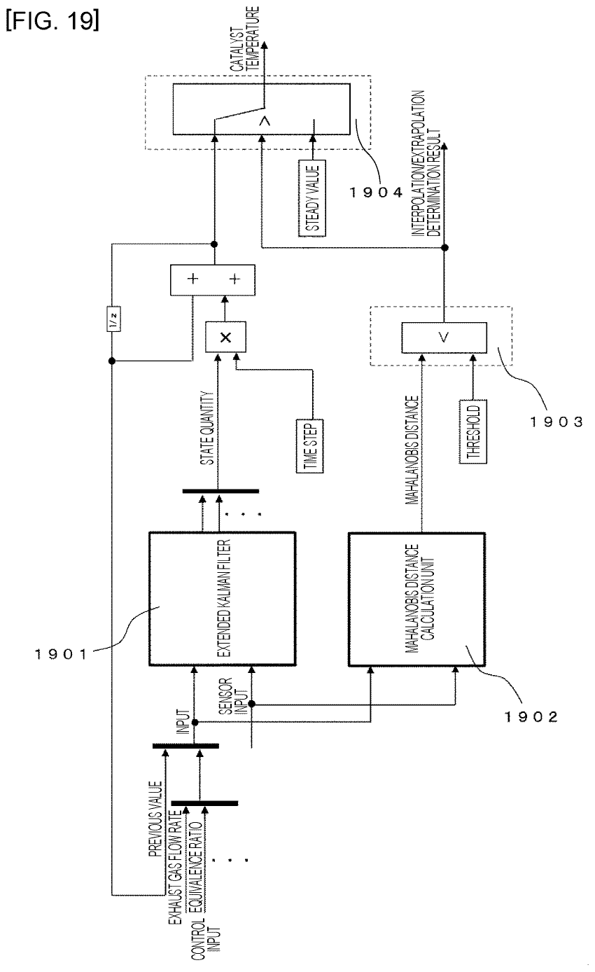

Therefore, regarding the value of the NOx purification rate with respect to the oxygen storage amount, the NOx purification rate of the deteriorated three-way catalyst indicated by the broken line in FIG. 18 is lower than the NOx purification rate of the new three-way catalyst indicated by the solid line in FIG. 18. Therefore, in order to keep the NOx purification rate high, it is necessary not only to keep the exhaust gas air-fuel ratio at the catalyst inlet at the ternary point but also to appropriately correct and control the exhaust gas air-fuel ratio at the catalyst inlet so that the oxygen storage ratio is within a range in which a predetermined NOx purification rate can be obtained in consideration of the state inside the catalyst that cannot be directly observed from the outside, that is, the current oxygen storage capacity and oxygen storage ratio of the three-way catalyst. As illustrated in FIG. 17, the predetermined range of the oxygen storage ratio is expressed as a deterioration time control range 36 at the time of catalyst deterioration and a new product control range 35 at the time of a new catalyst product, and the new product control range 35 is wider than the deterioration time control range 36.

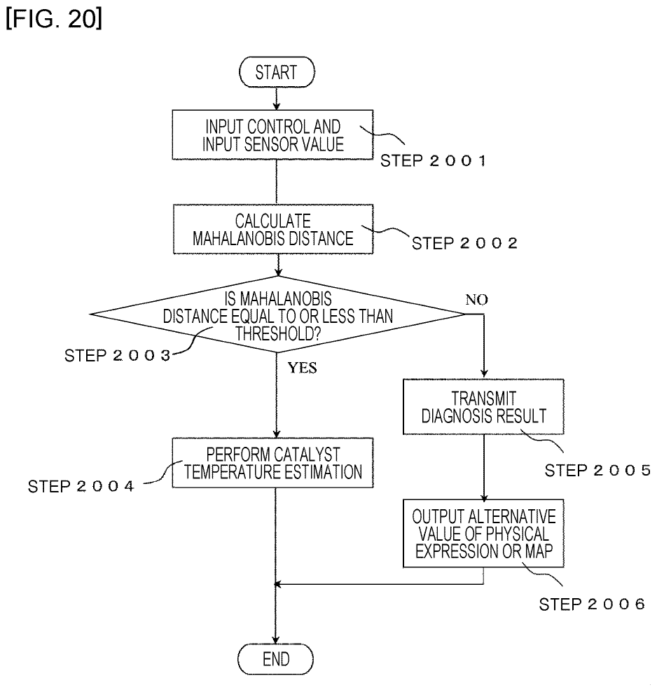

Next, a configuration of the present embodiment will be described with reference to FIG. 19. First, a control input such as an exhaust gas flow rate and an equivalence ratio and a sensor input such as an exhaust gas temperature sensor that detects an exhaust gas temperature on the downstream side of the catalyst are input from the ECU to an extended Kalman filter 1901, and the extended Kalman filter 1901 obtains a time differential value of the catalyst temperature based on these inputs. Thereafter, integral calculation is performed using the prescribed time step value and the previous value state quantity to obtain the current catalyst temperature. At the same time, the input value of the same type as that of an extended Kalman filter 1901 is input also in a Mahalanobis distance calculation unit 1902. The Mahalanobis distance at the current input is calculated using the input value. A comparison unit 1903 compares the prescribed threshold with the calculated Mahalanobis distance. In a case where the current Mahalanobis distance is larger than the threshold, 0 is output, and it is regarded that the current Mahalanobis distance is out of the learning range or the sensor is faulty. In a case where the current Mahalanobis distance is smaller than the threshold, 1 is output, and it is determined that the current Mahalanobis distance is within the learning range or the sensor is normal. Then, an interpolation/extrapolation result is recorded. In a switching unit 1904, in a case where 0 is input, it is assumed that the extended Kalman filter 1901 is operating outside the learning range or the sensor fault is occurring and a normal estimation calculation cannot be performed, and a prescribed steady value is output. In a case where 1 is input, it is regarded that the extended Kalman filter 1901 is operating within the learning range or the sensor is operating normally and normal estimation calculation has been performed, and the estimated catalyst temperature is output.

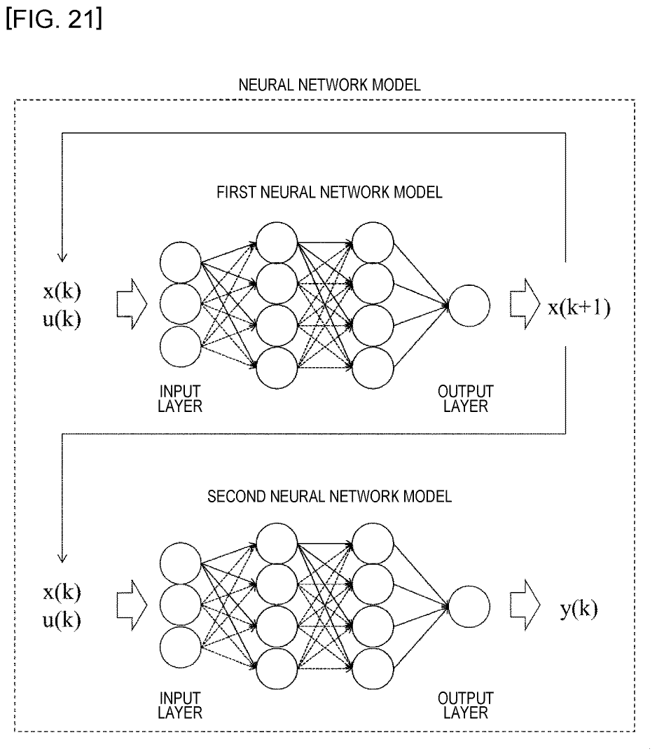

Next, a flowchart of the present embodiment will be described with reference to FIG. 20. In step 2001, control inputs and sensor input values are received from the ECU. In step 2002, the Mahalanobis distance is obtained from the ECU using the control input and the sensor input value. In step 2003, the threshold defined in step 2002 is compared with the calculated Mahalanobis distance. If it is smaller than the threshold, the process proceeds to step 2004, and if it is larger than the threshold, the process proceeds to step 2005. When the process proceeds to step 2004, since the extended Kalman filter is operating within the learning range or the sensor is operating normally, the catalyst temperature (differential value) is estimated by the extended Kalman filter using the control input and the sensor input value from the ECU, and the integral calculation is performed using the prescribed time step value and the previous value state quantity to obtain the current catalyst temperature. When the process proceeds to step 2005, since the extended Kalman filter is operating outside the learning range or the sensor is faulty, the diagnosis result is recorded and used as the sensor failure or the relearning data. An alternative value such as the estimated value calculated by the physical expression in step 2006 or the output value of MAP defined at the operating point is output.

The main features of the above-described embodiments can also be summarized as follows.

A processor (CPU 205, FIG. 2) of a control device (ECU 28, FIG. 1) calculates a state variable (for example, catalyst temperature) at the second timing from a state variable (for example, the previous value of the catalyst temperature, FIG. 19) of the vehicle at a first timing, a control input (for example, exhaust gas flow rate, equivalence ratio, FIG. 19) of the vehicle at a second timing after the first timing, and an observation value (sensor input: e.g., exhaust gas temperature downstream of catalyst, FIG. 19) at the second timing detected by a sensor of the vehicle. The processor approximates a state space model including a state equation (first expression of Expression (1)) related to a state variable (for example, catalyst temperature) and an observation equation (second expression of Expression (1)) related to an observation value (for example, the exhaust gas temperature on the downstream side of the catalyst) with a neural network model. The processor determines the reliability (accuracy) of the state variable (for example, catalyst temperature) at the second timing from the index (for example, the Mahalanobis distance) based on the control input (for example, exhaust gas flow rate, equivalence ratio) at the second timing and the observation value (for example, the exhaust gas temperature on the downstream side of the catalyst) at the second timing. Note that the observation value is a sensor value correlated with the state variable (second expression of Expression (1)).

This makes it possible to evaluate the reliability of the calculated value (estimated value) of the vehicle state variable that is not detected by the sensor. By using a highly reliable state variable for subsequent processing, the reliability of subsequent processing is also improved.

An example of the index is a Mahalanobis distance based on a control input (for example, exhaust gas flow rate, equivalence ratio) at the second timing and an observation value (for example, the exhaust gas temperature on the downstream side of the catalyst) at the second timing. Note that a value correlated with the Mahalanobis distance may be used as an index.

As a result, the reliability of the calculated value of the state variable at the second timing can be evaluated in consideration of the variance between the control input and the observation value.

For example, in a case where the Mahalanobis distance is larger than the threshold, the processor (CPU 205) determines that the reliability of the state variable (for example, catalyst temperature) at the second timing is low (comparison unit 1903, FIG. 19). Note that, in the second embodiment, in a case where the Mahalanobis distance is larger than the threshold, it is determined that the reliability of the state variable (for example, catalyst temperature) at the second timing is low, and 0 is output from the comparison unit 1903.

Accordingly, when the sensor is normal, interpolation (Mahalanobis distance≤Threshold) and extrapolation (Mahalanobis distance>Threshold) can be determined. When the sensor is abnormal (failure, adhesion of dirt, etc.), Mahalanobis distance>Threshold may be satisfied.

The state equation and the observation equation are nonlinear. The processor (CPU 205) calculates state variables (for example, catalyst temperature) using the extended Kalman filter 1901 (FIG. 19).

As a result, even if the state equation and the observation equation are nonlinear, the state variable can be easily calculated by linear approximation.

Specifically, in a case where the Mahalanobis distance is equal to or less than the threshold, the processor (CPU 205) outputs the state variable (for example, catalyst temperature) at the second timing which is calculated using the extended Kalman filter 1901 (step 2004, FIG. 20). When the Mahalanobis distance is larger than the threshold, the processor (CPU 205) outputs (transmits or stores) a diagnosis result indicating that the reliability of the state variable (for example, catalyst temperature) at the second timing is low or the sensor is faulty without outputting the state variable (for example, catalyst temperature) at the second timing which is calculated using the extended Kalman filter 1901 (step 2005, FIG. 20).

As a result, since the state variable with a low reliability is not used in the subsequent processing, it is possible to suppress a decrease in reliability of the subsequent processing.

For example, as illustrated in FIG. 21, the neural network model includes: a first neural network model including an input layer to which the state variable x(k) at the first timing and the control input u(k) at the first timing are input and an output layer to which the state variable x(k+1) at the second timing is output; and a second neural network model including an input layer to which the state variable x(k) at the first timing and the control input u(k) at the first timing are input and an output layer to which the observation value y(k) at the first timing is output.

As a result, the state variable and the observation value can be estimated without solving the state equation and the observation equation. In addition, the reliability of the state variable and the observation value estimated using the neural network model is improved by learning. By using the state variable estimated by the neural network model for the power train control, highly accurate power train control can be realized.

As illustrated in FIG. 19, the processor (CPU 205) inputs a state variable (for example, the previous value of the catalyst temperature) at the first timing, a control input (for example, exhaust gas flow rate, equivalence ratio) at the second timing, and an observation value (sensor input: e.g. exhaust gas temperature downstream of catalyst) at the second timing to the extended Kalman filter 1901, and acquires a time differential value (state quantity) of the state variable from the extended Kalman filter 1901. The processor (CPU 205) calculates the state variable (for example, catalyst temperature) at the second timing by integrating the time differential value (state quantity) of the state variable and adding the integrated value to the state variable (for example, the previous value of the catalyst temperature) at the first timing.

As a result, the state variable can be calculated at high speed.

In a case where the Mahalanobis distance is equal to or less than the threshold, the processor (CPU 205) outputs the state variable (for example, catalyst temperature) at the second timing which is calculated using the extended Kalman filter 1901. When the Mahalanobis distance is larger than the threshold, the processor (CPU 205) outputs the alternative value derived from the physical expression or the map as the state variable (for example, catalyst temperature) without outputting the state variable (for example, catalyst temperature) at the second timing which is calculated using the extended Kalman filter 1901 (step 2006, FIG. 20).

As a result, for example, the subsequent processing using the state variable is not interrupted.

The processor (CPU 205) performs machine learning using the state variable (for example, the previous value of the catalyst temperature) at the first timing which is calculated using the extended Kalman filter 1901, the control input (for example, exhaust gas flow rate, equivalence ratio) at the first timing, and the state variable (for example, catalyst temperature) at the second timing which is calculated using the extended Kalman filter 1901 as train data of the first neural network model. In addition, the processor (CPU 205) performs machine learning using the state variable (for example, the previous value of the catalyst temperature) at the first timing which is calculated using the extended Kalman filter 1901, the control input (for example, exhaust gas flow rate, equivalence ratio) at the first timing, and the observation value (for example, the exhaust gas temperature on the downstream side of the catalyst) at the first timing as train data of the second neural network model.

As a result, machine learning can be performed using the state variable calculated using the extended Kalman filter for the state variable not detected by the sensor.

The processor (CPU 205) performs the machine learning when the Mahalanobis distance is equal to or less than the threshold, and does not perform the machine learning when the Mahalanobis distance is larger than the threshold.

Thus, the machine learning can be performed using the highly reliable state variable calculated using the extended Kalman filter. As a result, the reliability of the state variable and the observation value estimated using the neural network model is improved. By using the state variable estimated by the neural network model for the power train control, highly accurate power train control can be realized.

Note that the present invention is not limited to the above-described embodiments, and it goes without saying that various other application examples and modifications can be taken without departing from the gist of the present invention described in the claims.

For example, the above-described embodiments describe the configuration of the system in detail and specifically for easy understanding of the present invention, and are not necessarily limited to those having all the described configurations. In addition, it is possible to add, delete, and replace other configurations for a part of the configuration of the present embodiment.

In addition, the control lines and the information lines indicate what is considered to be necessary for the description, and do not necessarily indicate all the control lines and the information lines on the product. In practice, it may be considered that almost all the configurations are connected to each other.

In addition, some or all of the above-described configurations, and the like may be achieved by hardware, for example, by designing with an integrated circuit. In addition, each of the above-described configurations, functions, and the like may be achieved by software by a processor interpreting and executing a program for achieving each function. Information such as a program, a table, and a file for achieving each function can be stored in a recording device such as a memory, a hard disk, and a solid state drive (SSD), or a recording medium such as an IC card, an SD card, and a DVD.

Embodiments of the present invention may have the following aspects.
(1). A power train system control device for an automobile including a sensor that detects a current state, the power train system control device including a means for determining a validity of a state quantity estimation result using a state observer based on an abnormality diagnosis index defined by an input of a neural network model and a sensor detection value, in which the state observer includes an index value setting unit that obtains a determination threshold and the abnormality diagnosis index based on a control input and the sensor detection value as index for determining a validity of a state estimation amount and a neural network model approximating a state space model including the sensor detection target as one of output variables based on a state variable related to an automobile which is detected by a sensor, the control input for controlling the automobile, and the state estimation amount estimated by the state observer.
(2). The power train system control device including a means for using a Mahalanobis distance as the abnormality diagnosis index defined by the control input and the sensor detection value.
(3). The power train system control device according to (1), including a means for determining a validity of a state quantity estimation result of the state observer based on the Mahalanobis distance.
(4). The power train system control device according to (1), including, as the state observer, a means for performing state quantity estimation using an extended Kalman filter capable of considering non-linearity.
(5). The power train system control device according to (1), including a means for stopping state quantity estimation using the extended Kalman filter, diagnosing that the state quantity estimation or the sensor is abnormal, and notifying or recording a diagnosis result to an outside when the Mahalanobis distance is a predetermined value or more.
(6). The power train system control device according to (1), in which the neural network model approximating the state space model includes a transient neural network model approximating a state space model using a previous value as one of inputs.
(7). The power train system control device according to (1), in which the extended Kalman filter obtains a time differential value of a state quantity, adds the time differential value to a previous value, and estimates a current state quantity.
(8). The power train system control device according to (1), after the state quantity estimation using the extended Kalman filter is stopped when the Mahalanobis distance is a predetermined value or more, an alternative value obtained from a physical expression or a MAP is output.

According to (1) to (8), the validity/invalidity of the transient neural network model and the sensor can be diagnosed with minimum information and calculation, and the reliability of the control software can be guaranteed.

### REFERENCE SIGNS LIST

1 internal combustion engine
20 catalyst upstream air-fuel ratio sensor
21 exhaust purification catalyst
22 rear oxygen sensor
28 ECU
51 exhaust gas flow rate calculation unit
52 catalyst upstream state quantity estimation unit
53 catalyst downstream state quantity estimation unit
54 correction unit
55 NOx sensor diagnosis unit
56 fuel injection amount correction unit
56a fuel injection amount correction map
57 fuel composition discrimination unit
100 internal combustion engine control system
110 post-processing system

1. A control device comprising a processor, wherein
the processor is configured to execute:
calculating a state variable at a second timing from a state variable of a vehicle at a first timing, a control input of the vehicle at a second timing after the first timing, and an observation value at the second timing which is detected by a sensor of the vehicle;
approximating, with a neural network model, a state space model including a state equation related to the state variable and an observation equation related to the observation value; and
determining a reliability of the state variable at the second timing from an index based on the control input at the second timing and the observation value at the second timing.

2. The control device according to claim 1, wherein the index is a Mahalanobis distance based on the control input at the second timing and the observation value at the second timing.

3. The control device according to claim 2, wherein the processor determines that a reliability of the state variable at the second timing is low when the Mahalanobis distance is larger than a threshold.

4. The control device according to claim 1, wherein
the state equation and the observation equation are non-linear, and
the processor is configured to execute:
calculating the state variable using an extended Kalman filter.

5. The control device according to claim 2, wherein
the processor is configured to execute:
outputting the state variable at the second timing which is calculated using an extended Kalman filter in a case where the Mahalanobis distance is equal to or less than a threshold; and
outputting, in a case where the Mahalanobis distance is larger than a threshold, a diagnosis result indicating that a reliability of the state variable at the second timing is low or the sensor is faulty without outputting the state variable at the second timing which is calculated using the extended Kalman filter.

6. The control device according to claim 4, wherein the neural network model includes:
a first neural network model including an input layer to which the state variable at the first timing and the control input at the first timing are input and an output layer to which the state variable at the second timing is output; and
a second neural network model including an input layer to which the state variable at the first timing and the control input at the first timing are input and an output layer to which the observation value at the first timing is output.

7. The control device according to claim 4, wherein the processor is configured to execute:
inputting the state variable at the first timing, the control input at the second timing, and the observation value at the second timing to the extended Kalman filter, and acquiring a time differential value of the state variable from the extended Kalman filter; and
integrating a time differential value of the state variable and adding an integrated value to the state variable at the first timing to calculate the state variable at the second timing.

8. The control device according to claim 2, wherein the processor is configured to execute:
outputting, in a case where the Mahalanobis distance is equal to or less than a threshold, the state variable at a second timing which is calculated using an extended Kalman filter; and
outputting, in a case where the Mahalanobis distance is larger than a threshold, an alternative value derived from a physical expression or a map as the state variable without outputting the state variable at the second timing which is calculated using the extended Kalman filter.

9. The control device according to claim 6, wherein the processor is configured to execute machine learning using:
the state variable at the first timing which is calculated using the extended Kalman filter, the control input at the first timing, and the state variable at the second timing which is calculated using the extended Kalman filter as train data of the first neural network model; and
the state variable at the first timing which is calculated using the extended Kalman filter, the control input at the first timing, and the observation value at the first timing as train data of the second neural network model.

10. The control device according to claim 9, wherein
the index is a Mahalanobis distance based on the control input at the second timing and the observation value at the second timing, and
the processor is configured to:
perform the machine learning in a case where the Mahalanobis distance is equal to or less than a threshold; and
not perform the machine learning in a case where the Mahalanobis distance is larger than a threshold.
